(19) United States
(12) Patent Application Publication
(10) Pub. No.: US 2025/0105684 A1
(43) Pub. Date: Mar. 27, 2025

(54) COOLING OF STATOR AND WINDINGS OF ELECTRIC MOTOR IN INTEGRATED COMPRESSOR

(71) Applicant: Solar Turbines Incorporated, San Diego, CA (US)

(72) Inventors: Sahand PIROUZPANAH, San Diego, CA (US); Michael B. MCCUNE, Escondido, CA (US); Lei ZHU, San Diego, CA (US); Jess Lee FREEMAN, Poway, CA (US); Marco FESTA, Falkensee (DE); Matthias Johannes BURGHARD, Berlin (DE)

(73) Assignee: Solar Turbines Incorporated, San Diego, CA (US)

(21) Appl. No.: 18/372,541

(22) Filed: Sep. 25, 2023

(51) Int. Cl. H02K 1/20

(52) U.S. Cl. CPC H02K 1/20; H02K 2201/03

(57) ABSTRACT

An integrated compressor comprises an electric motor that is prone to high temperatures. In a first cooling feature, axial and/or radial cooling channels are provided through the stator of the motor to supply coolant to portions of the stator that are prone to high temperatures. In a second cooling feature, jets are used to spray coolant towards the end-windings of the motor, to thereby cool the end-windings.

### TECHNICAL FIELD

The embodiments described herein are generally directed to integrated compressors, and, more particularly, to cooling the stator and/or windings of an electric motor in an integrated compressor.

### BACKGROUND

Integrated compressors are hermetically sealed systems in which a compressor is coupled to an electric motor. During operation of an integrated compressor, the electric motor is subjected to high pressures and/or dense cooling gases. Maintaining the temperatures of the motor, including its windings and rotor, below their critical temperatures is important to the health, lifetime, efficiency, and operating envelope of the electric motor. The temperatures of these critical components are determined by the geometry of the electric motor, the solid material properties, electromagnetic losses, windage losses, the temperature of the cooling gas, and the like.

U.S. Pat. No. 8,597,001 describes a turbocompressor, in which the stator is cooled by cooling gas ducts, including a radial gas duct through the stator. In addition, the end-windings are cooled by radial holes that are all at the same radial distance from the longitudinal axis of the turbocompressor.

U.S. Pat. No. 10,243,419 describes an electric motor with stator windings that are cooled by a winding groove around the insulation of the stator windings. Cooling liquid is supplied to the winding grooves to cool the stator windings.

The present disclosure is directed toward overcoming one or more of the problems discovered by the inventors.

### SUMMARY

In an embodiment, a motor comprises: a motor rotor with a longitudinal axis; a motor stator encircling the motor rotor and concentric with the longitudinal axis, wherein the motor stator includes at least one axial cooling channel that extends through the motor stator, parallel to the longitudinal axis; and an air gap between the motor stator and the motor rotor.

In an embodiment, a motor comprises: a motor rotor with a longitudinal axis; a motor stator encircling the motor rotor and concentric with the longitudinal axis; and an air gap between the motor stator and the motor rotor, wherein the motor stator includes at least one cooling channel that extends through the motor stator, parallel to the longitudinal axis, and a plurality of radial cooling channels that extend through the motor stator, perpendicular to the longitudinal axis, wherein, for each of the plurality of radial cooling channels, a first end of the radial cooling channel is in fluid communication with the air gap and a second end of the radial cooling channel is in fluid communication with at least one cavity that is radially outward from the motor stator, and wherein at least a subset of the plurality of radial cooling channels are in direct fluid communication with the at least one axial cooling channel.

In an embodiment, an integrated compressor comprises: a shaft having a longitudinal axis; a plurality of rotor assemblies attached to the shaft; and a motor that drives rotation of the shaft around the longitudinal axis, wherein the motor comprises a motor rotor that is concentric with the longitudinal axis, a motor stator encircling the motor rotor and concentric with the longitudinal axis, wherein the motor stator includes at least one axial cooling channel that extends through the motor stator, parallel to the longitudinal axis, and an air gap between the motor stator and the motor rotor.

### BRIEF DESCRIPTION OF THE DRAWINGS

The details of embodiments of the present disclosure, both as to their structure and operation, may be gleaned in part by study of the accompanying drawings, in which like reference numerals refer to like parts, and in which:

FIG. 1 is a cross-sectional schematic diagram of an integrated compressor, according to an embodiment;

FIG. 2 is a cross-sectional schematic diagram of a portion of a motor of an integrated compressor, according to an embodiment;

FIG. 3 is a perspective view of a portion of a motor of an integrated compressor, according to an embodiment;

FIG. 4 is a cross-sectional schematic diagram of a portion of a motor of an integrated compressor, according to an embodiment;

FIG. 5 is a perspective view of a portion of a motor of an integrated compressor, according to an embodiment;

FIG. 6 is a cross-sectional schematic diagram of a portion of a motor of an integrated compressor, according to an embodiment; and

FIG. 7 is a perspective view of a portion of a motor of an integrated compressor, according to an embodiment.

### DETAILED DESCRIPTION

The detailed description set forth below, in connection with the accompanying drawings, is intended as a description of various embodiments, and is not intended to represent the only embodiments in which the disclosure may be practiced. The detailed description includes specific details for the purpose of providing a thorough understanding of the embodiments. However, it will be apparent to those skilled in the art that embodiments of the invention can be practiced without these specific details. In some instances, well-known structures and components are shown in simplified form for brevity of description.

For clarity and ease of explanation, some surfaces and details may be omitted in the present description and figures. In addition, references herein to “forward” and “aft” are used to describe the relative positions of components, as depicted in the drawings, and do not imply any absolute orientation of components or their relationship to a flow of fluid, such as gas. Also, it should be understood that, as used herein, the terms “side,” “top,” “bottom,” “front,” “rear,” “above,” “below,” and the like are used for convenience to convey the relative positions of various components with respect to each other, and do not imply any specific orientation of those components in absolute terms (e.g., with respect to the external environment or the ground).

It should also be understood that the various components illustrated herein are not necessarily drawn to scale. In other words, the features disclosed in various embodiments may be implemented using different relative dimensions within and between components than those illustrated in the drawings.

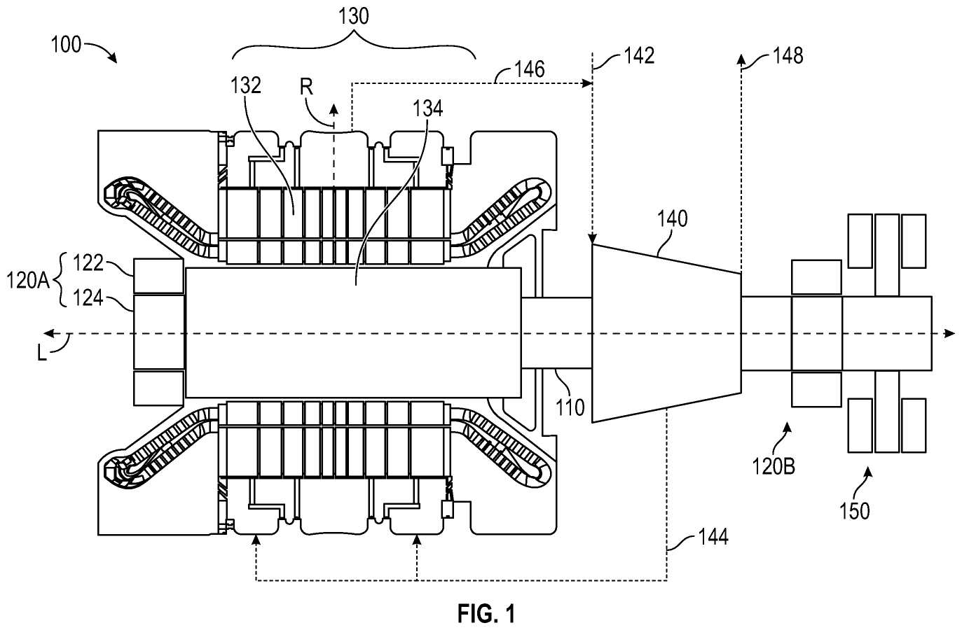

FIG. 1 is a cross-sectional schematic diagram of an integrated compressor 100, according to an embodiment. Integrated compressor 100 comprises a compressor housing enclosing a shaft 110 with a central longitudinal axis L. Shaft 110 may comprise a plurality of joined components. A number of other components of integrated compressor 100 are concentric with longitudinal axis L and may be annular around longitudinal axis L. A radial axis may refer to any axis or direction that radiates outward from longitudinal axis L at a substantially orthogonal angle to longitudinal axis L, such as radial axis R in FIG. 1. Thus, the term “radially outward” should be understood to mean farther from or away from longitudinal axis L, whereas the term “radially inward” should be understood to mean closer or towards longitudinal axis L. As used herein, the term “radial” will refer to any axis or direction that is substantially perpendicular to longitudinal axis L, and the term “axial” will refer to any axis or direction that is substantially parallel to longitudinal axis L.

In an embodiment, integrated compressor 100 comprises a first bearing system 120A, a motor 130, a compression system 140, a second bearing system 120B, and a thrust bearing system 150. First bearing system 120A and second bearing system 120B (collectively referred to herein as bearing systems 120) may comprise a radial magnetic bearing (RMB) positioned annularly around longitudinal axis L. For example, each bearing system 120 may comprise an RMB stator 122 that is concentric with an RMB rotor 124 around longitudinal axis L. RMB rotor 124 may form or be fixed around a component of shaft 110. RMB stator 122 utilizes a magnetic suspension force to suspend RMB rotor 124 through the center of RMB stator 122 without contacting RMB stator 122. Thus, shaft 110, including RMB rotor 124, may rotate freely within RMB stator 122 without physically contacting RMB stator 122. Similarly, thrust bearing system 150 may comprise a thrust magnetic bearing (TMB) that is positioned annularly around longitudinal axis L. The thrust magnetic bearing may also comprise a stator and a rotor that is concentric with the stator and suspended by a magnetic force within the stator, but is designed to take axial thrust loads during operation of integrated compressor 100.

Motor 130 comprises a motor stator 132 and a motor rotor 134. Motor stator 132 may comprise one or a plurality of electromagnetic coils in the form of windings that may be connected to a power source. As energy flows through the electromagnetic coil(s), a magnetic field is created that drives the rotation of motor rotor 134 around longitudinal axis L. Motor rotor 134 may form or be fixed around a component of shaft 110, such that, when motor stator 132 is powered, motor rotor 134, and thereby shaft 110, are driven to rotate within the housing of integrated compressor 100.

Compression system 140 may comprise one or more stages of rotor assemblies. An inlet path 142 feeds the working fluid (e.g., the primary gas, such as air, methane, etc.) into the first stage of compression system 140. Inlet path 142 may comprise a radial channel through the housing of integrated compressor 100 to provide fluid communication between an exterior of integrated compressor 100 and the first stage of compression system 140. Thus, inlet path 142 may be connected to a pipeline (e.g., via the fastening of corresponding flanges) or another source of the working fluid. The working fluid is compressed through each stage of compression system 140. It should be understood that each stage in compression system 140 may comprise one or more airfoils that are fixed to and extend radially from shaft 110 and rotate with shaft 110. Once the working fluid has been compressed through the final stage of compression system 140, the working fluid may be discharged through an outlet path 148. Outlet path 148 may comprise a radial channel through the housing of integrated compressor 100. Outlet path 148 may be connected to a pipeline (e.g., via the fastening of corresponding flanges) or another destination of the compressed working fluid.

A bleed path 144 may fluidly connect compression system 140 to a coolant system of motor 130, to provide working fluid from compression system 140 to a coolant inlet of motor 130. In other words, relatively cool working fluid is extracted from one or more stages of compression system 140 and supplied as coolant to motor 130 via bleed path 144. Similarly, a reintroduction path 146 may fluidly connect the coolant system of motor 130 to inlet path 142, to reintroduce working fluid from a coolant outlet of motor 130 to compression system 140. In other words, coolant, which has extracted heat from motor 130, is extracted from motor 130 and supplied as working fluid to the first stage of compression system 140.

It should be understood that the illustrated integrated compressor 100 is simply one example of an integrated compressor. Thus, while integrated compressor 100 is illustrated with a beam-style design, integrated compressor 100 could utilize any different type of design, including an overhung-style design (e.g., with the inlet and outlet of compression system 140 on opposite sides of motor 130). The arrangements of bearing systems 120 and 150 may differ depending on the chosen design. In addition, it should be understood that various types of motor 130 may be used in integrated compressor 100, including a motor 130 with any number of poles.

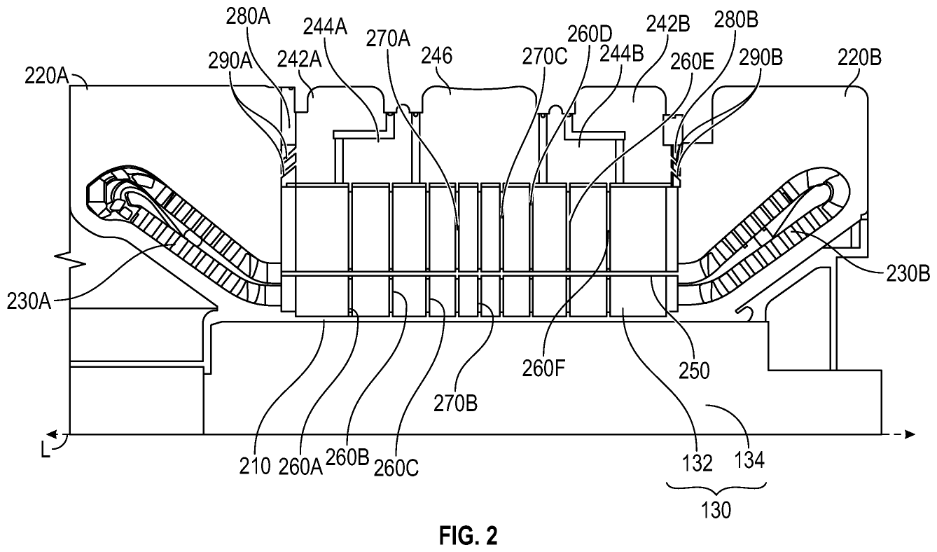

FIG. 2 is a cross-sectional schematic diagram of a portion of motor 130 of integrated compressor 100, according to an embodiment. An air gap 210 exists between motor stator 132 and motor rotor 134. In addition, there are end-winding cavities 220A and 220B on either side of motor stator 132 to accommodate end-windings 230A and 230B, respectively. Each end-winding 230 extends from a respective end of motor stator 132, and conducts electricity to generate the magnetic field that drives rotation of motor rotor 134. Inlets 242A and 242B may exist radially outward from motor stator 132 and be supplied with coolant for cooling motor stator 132 (e.g., via bleed path 144). Cavities 244A, and 244B may exist radially outward from motor stator 132 and provide a flow path between radial cooling channels described herein. In an embodiment, cavities 244A and 244B may also be inlets that are supplied with coolant for cooling motor stator 132. In this case, inlets 242A and 242B may be primary inlets with higher coolant flow, and cavities 244A and 244B may be secondary inlets with lower coolant flow. Outlet 246 may exist radially outward from motor stator 132 and provide an exit for the coolant flowing through motor stator 132 (e.g., via reintroduction path 146). As discussed above, the coolant may comprise compressed working fluid that is extracted or bled from one of the stages of compression system 140 and channeled into inlets 242A and/or 242B via bleed path 144.

It should be understood that, as used herein, the letter may be dropped from a reference numeral whenever a reference to an element can be applied equally to all components sharing the numeric portion of that reference numeral. For example, a reference to end-winding cavity 220 may apply to forward end-winding cavity 220A and/or aft end-winding cavity 220B. Similarly, a reference to end-winding 230 may apply equally to end-windings 230A and 230B, a reference to inlet 242 may apply equally to inlets 242A and 242B, a reference to cavity 244 may apply equally to cavities 244A and 244B, and so on and so forth.

As illustrated, a plurality of cooling channels may be formed in motor stator 132. For example, an axial cooling channel 250 may be formed axially through motor stator 132. Axial cooling channel 250 may be in fluid communication on the forward end with end-winding cavity 220A and on the aft end with end-winding cavity 220B. Axial cooling channel 250 may be positioned closer to air gap 210 than to inlets 242, cavities 244, and outlet 246 to improve the cooling of motor stator 132 in the area in which it is prone to higher temperatures (i.e., closer to air gap 210). It should be understood that motor stator 132 may comprise a plurality of axial cooling channels 250, that are parallel to each other, at the same radial distance from longitudinal axis L, and spaced (e.g., at equidistant intervals) around longitudinal axis L. Although not illustrated, different sets of axial cooling channels 250 could be positioned at different radial distances from longitudinal axis L, to stagger axial cooling within motor stator 132. In this case, the density of axial cooling channels 250 may be greater on a radially inner end of motor stator 132 than on a radially outer end of motor stator 132 to provide greater cooling within the radially inner portion of motor stator 132.

In addition to axial cooling channels 250, radial cooling channels 260 and 270 may be formed radially through motor stator 132. In an embodiment, radial cooling channels 260 are not in direct fluid communication with axial cooling channel 250, whereas radial cooling channels 270 are in direct fluid communication with axial cooling channel 250. In the illustrated cross-section, three radial cooling channels 260A, 260B, and 260C, and are upstream from three radial cooling channels 270A, 270B, and 270C, and three radial cooling channels 260D, 260E, and 260F are downstream from radial cooling channels 270A, 270B, and 270C. However, it should be understood that other configurations are possible, including a different number (e.g., zero, one, two, four, five, etc.) of forward radial cooling channels 260, a different number (e.g., zero, one, two, four, five, etc.) of aft radial cooling channels 260, and/or a different number (e.g., zero, one, two, four, five, etc.) of radial cooling channels 270. In addition, it should be understood that motor stator 132 may comprise a plurality of each of radial cooling channels 260A, 260B, 260C, 270A, 270B, 270C, 260D, 260E, 260F, with each plurality spaced (e.g., at equidistant intervals) around longitudinal axis L.

In an embodiment, the density of radial cooling channels 260 and 270 may increase from a forward axial end of motor stator 132 towards the center of motor stator 132 and/or may increase from an aft axial end of motor stator 132 towards the center of motor stator 132. In other words, the density of radial cooling channels 260 and 270 may be greater in the axial center of motor stator 132, which is prone to higher temperatures than the axial ends. In addition, the density of radial cooling channels 260 and 270 may be greater in the aft half of motor stator 132 than in the forward half of motor stator 132, since the aft half of motor stator 132 may be prone to higher temperatures than the forward half of motor stator 132.

For example, in the illustrated embodiment, the forward half of motor stator 132 comprises three radial cooling channels 260A, 260B, and 260C, which are not in fluid communication with axial cooling channel 250, with the distance between the forward edge of motor stator 132 and radial cooling channel 260A being greater than the distance between radial cooling channels 260A and 260B, the distance between radial cooling channels 260A and 260B being greater than the distance between radial cooling channels 260B and 260C, and the distance between radial cooling channels 260B and 260C being greater than the distance between radial cooling channels 260C and 270A. Notably, radial cooling channels 270A, 270B, and 270C, which are in direct fluid communication with axial cooling channel 250, are positioned substantially in the center of motor stator 132 (e.g., symmetrically). The aft half of motor stator 132 comprises three radial cooling channels 260D, 260E, and 260F, which are not in direct fluid communication with axial cooling channel 250. The distance between radial cooling channels 260D and 260E is greater than the distance between radial cooling channels 270C and 260D, the distance between radial cooling channels 260E and 260F is greater than the distance between radial cooling channels 260D and 260E, and the distance between radial cooling channel 260F and the aft edge of motor stator 132 is greater than the distance between radial cooling channels 260E and 260F. It should be understood that this is just one non-limiting example, and that alternative configurations of cooling channels 260 and/or 270 are possible, depending on the particular characteristics of stator motor 132. In general, the density of cooling channels 260 and 270 should be greater in areas of motor stator 132 that are prone to higher temperatures than in areas of motor stator 132 that are prone to lower temperatures.

Cooling channels 250, 260, and 270 enable coolant, which may be the same as the working fluid, to flow through motor stator 132, to thereby cool motor stator 132. In particular, each axial cooling channel 250 enables coolant to flow axially through motor stator 132. Each radial cooling channel 260 enables coolant to flow radially through motor stator 132 between air gap 210 and either cavity 244A or 244B, or outlet 246. Similarly, each radial cooling channel 270 enables coolant to flow radially through motor stator 132 between air gap 210 and outlet 246. In addition, each radial cooling channel 270 is in direct fluid communication with axial cooling channel 250 to enable coolant to flow between axial cooling channel 250 and radial cooling channels 270. Notably, radial cooling channels 260 and 270 are in indirect fluid communication with each other by virtue of their fluid communication with air gap 210 and either cavity 244A or 244B, or outlet 246. For example, coolant may flow from radial cooling channel 260A into cavity 244A and from cavity 244A into radial cooling channel 260B, and/or vice versa. Similarly, coolant may flow from radial cooling channel 260C into outlet 246 and at least some coolant which does not exit through outlet 246 may flow from outlet 246 into radial cooling channel 270A, and/or vice versa. Similarly, coolant may flow from radial cooling channel 270A into outlet 246 and at least some coolant which does not exit through outlet 246 may flow from outlet 246 into radial cooling channel 270B, and/or vice versa. Thus, coolant may flow between two radial cooling channels 260, between two radial cooling channels 270, and between radial cooling channel 260 and radial cooling channel 270.

Motor stator 132 may comprise a forward press plate 280A that separates end-winding cavity 220A from inlet 242A and an aft press plate 280B that separates end-winding cavity 220B from inlet 242B. In an embodiment, one or more jets 290 may be formed through forward press plate 280A and/or aft press plate 280B to fluidly connect inlet 242 to end-winding cavity 220. For example, one or a plurality of jets 290A may be formed through forward press plate 280A to spray coolant from inlet 242A into cavity 220A, to thereby cool end-winding 230A. Similarly, one or a plurality of jets 290B may be formed through aft press plate 280B to spray coolant from inlet 242B into cavity 220B, to thereby cool end-winding 230B. Jets 290 may be formed at any suitable angle with respect to a radial axis and preferably within a range of 35-55 degrees, such as a 45-degree angle. In particular, each jet 290 may be angled towards end-winding 230 to spray coolant from inlet 242 towards end-winding 230.

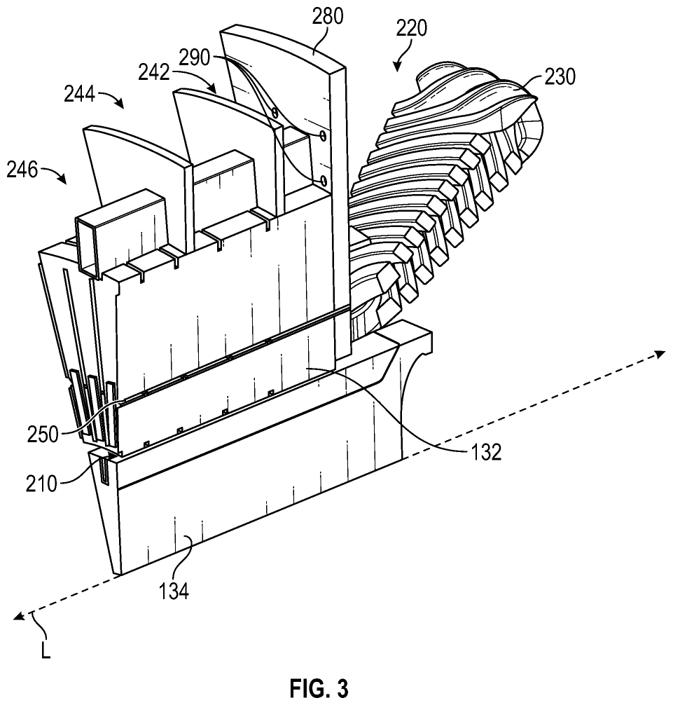

FIG. 3 is a perspective view of a portion of motor 130 of integrated compressor 100, according to an embodiment. As shown, inlets 242, cavities 220 and 244, and outlet 246 each form an annulus around longitudinal axis L. Jets 290 may be provided through press plate 280 at equidistant intervals around longitudinal axis L and at one or a plurality radial distances from longitudinal axis L. While jets 290 are illustrated at two radial distances from longitudinal axis L, it should be understood that press plate 280 may consist of jets 290 at any number of radial distances from longitudinal axis L, including a single radial distance or three or more radial distances.

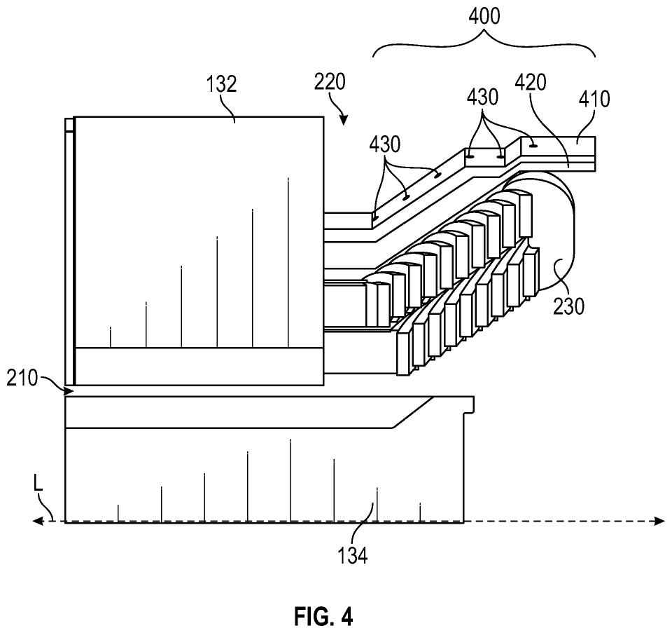

FIG. 4 is a cross-sectional schematic diagram of a portion of motor 130 of integrated compressor 100, according to an embodiment. In the illustrated embodiment, a winding shroud 400 extends from a forward and/or aft end of motor stator 132, radially outward from a position at which end-winding 230 connects to motor stator 132, to thereby surround end-winding 230. Winding shroud 400 may be used instead of or in addition to jets 290 to cool end-winding 230.

As illustrated, the inner diameter of winding shroud 400 may increase as a distance from the end of motor stator 132 increases. Winding shroud 400 may have a shape that generally follows the shape of end-winding 230 in an axial direction, such that a radial distance or spacing between a radially inward-facing surface of winding shroud 400 and a radially outward-facing surface of end-winding 230 is substantially constant along an axial direction through cavity 220. In other words, an inner diameter of winding shroud 400 may increase, as the distance from the end of motor stator 132 increases, at the same rate that an outer diameter of end-winding 230 increases as the distance from the end of motor stator 132 increases. Alternatively, the radial distance or spacing between the radially inward-facing surface of winding shroud 400 and the radially outward-facing surface of end-winding 230 may be non-constant along an axial direction through cavity 220. It should be understood that winding shroud 400 may be annular around longitudinal axis L.

Winding shroud 400 may comprise a shroud portion 410 that is supported by ribs 420, which extend from the end of motor stator 132 at a position radially inward from shroud portion 410. A plurality of jets 430 may be formed through shroud portion 410 at circumferential positions that are between the positions of ribs 420. Jets 430 may be formed as through-holes in shroud portion 410 that fluidly connect a portion of end-winding cavity 220 that is radially outward from winding shroud 400 to a portion of end-winding cavity 220 that is radially inward from winding shroud 400 and contains end-winding 230. In an embodiment, each jet 430 is oriented along a radial axis. Alternatively, jets 430 may be angled with respect to a radial axis. Jets 430 may be formed at a plurality of positions, both around the circumference of shroud portion 410 and in an axial direction. Jets 430 may be equidistantly spaced around the circumference of shroud portion 410 and/or in the axial direction. Coolant may be supplied to the portion of end-winding cavity 220 that is radially outward from winding shroud 400, to flow through jets 430 and be sprayed towards end-winding 230. Since the shape of winding shroud 400 generally matches the shape of end-winding 230, the coolant can be sprayed at the entire length of end-winding 230 from a substantially constant distance. However, in an alternative embodiment, the shape of winding shroud 400 may not generally match the shape of end-winding 230 and/or the coolant may be sprayed from different distances along the length of end-winding 230.

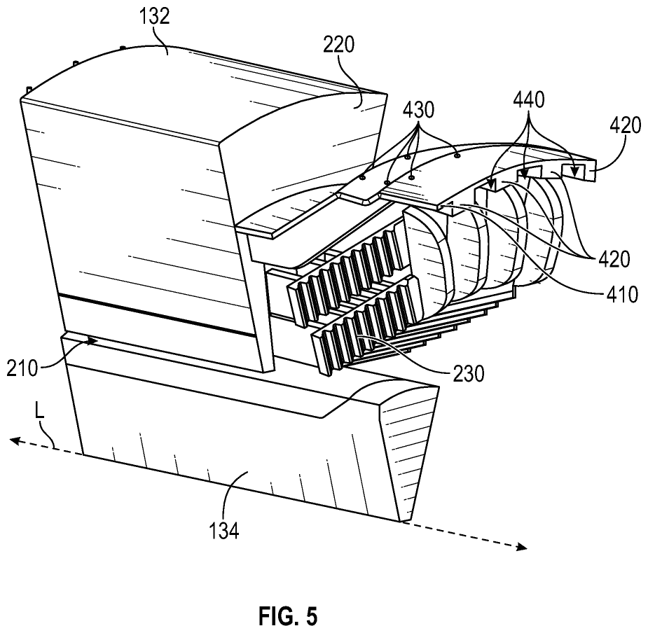

FIG. 5 is a perspective view of a portion of motor 130 of integrated compressor 100, according to an embodiment. As illustrated, ribs 420 extend along the radially inward-facing surface of shroud portion 410 in an axial direction. The spaces between adjacent ribs 420 form grooves 440 in the axial direction. Again, since the shape of winding shroud 400, including shroud portion 410 and ribs 420, generally follows the shape of end-winding 230, grooves 440 also generally follow the shape of end-winding 230, such that a radial distance or spacing between each groove 440 and a radially outward-facing surface of end-winding 230 is substantially constant along an axial direction through cavity 220. In an alternative embodiment, the radial distance or spacing between each groove 440 and the radially outward-facing surface of end-winding 230 may be non-constant along an axial direction through cavity 220. Grooves 440 accommodate the fluid, which may be the same as the working fluid within integrated compressor 100, that recirculates within the portion of cavity 220 radially inward from winding shroud 400. Thus, this fluid, which will generally have a higher temperature than the coolant sprayed through jets 430, may recirculate in grooves 440 away from the surface and insulation of end-winding 230.

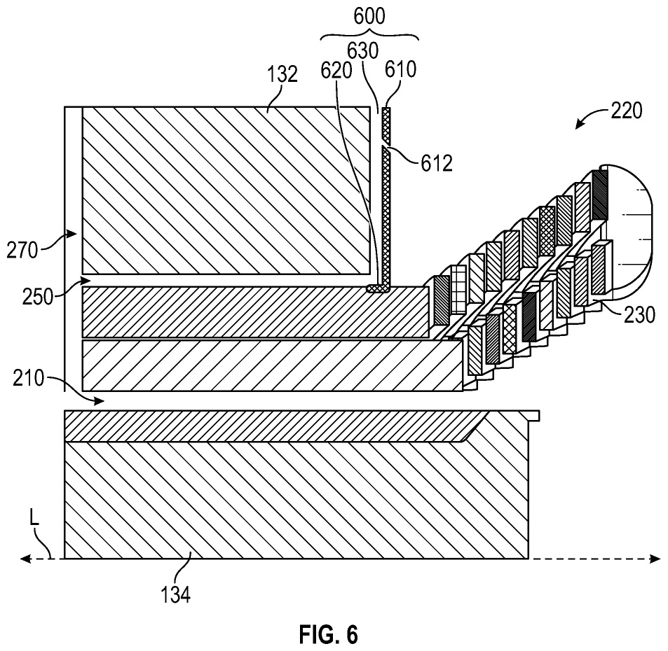

FIG. 6 is a cross-sectional schematic diagram of a portion of motor 130 of integrated compressor 100, according to an embodiment. In the illustrated embodiment, a flow splitter 600 is provided on the forward and/or aft end of motor stator 132, so as to reduce the volume of end-winding cavity 220. Flow splitter 600 may be used instead of or in addition to jets 290 and/or winding shroud 400. Flow splitter 600 comprises a radial wall 610 and at least one axial wall 620 that define a radial cooling channel 630 between the end of motor stator 132 and radial wall 610. It should be understood that flow splitter 600 and radial cooling channel 630 may be annular around longitudinal axis L.

In an embodiment, radial cooling channel 630 is in fluid communication with axial cooling channel 250. For example, an end of each axial cooling channel 250 may open into radial cooling channel 630 at a radially inward end of radial cooling channel 630. In an embodiment in which a flow splitter 600 is provided on both ends of motor stator 132, both ends of each axial cooling channel 250 may open into the radial cooling channel 630 of the opposing flow splitters 600 on both ends of motor stator 132 to provide a fluid path between the opposing radial cooling channels 630. Coolant, which may be the same as the working fluid through compression system 140, may be supplied to radial cooling channel 630 from a radially outward position by a coolant system (e.g., which bleeds working fluid from a stage of compression system 140 via bleed path 144). The coolant may flow radially inward along radial cooling channel 630 and into each axial cooling channel 250.

In an embodiment, one or more jets 612 may be formed through radial wall 610 of flow splitter 600 to fluidly connect radial cooling channel 630 to end-winding cavity 220. Jets 612 may be formed at any suitable angle with respect to a radial axis and preferably within a range of 35-55 degrees, such as a 45-degree angle. In particular, jet(s) 612 may be angled towards end-winding 230 to spray coolant from radial cooling channel 630 towards end-winding 230. Thus, coolant supplied to radial cooling channel 630 is sprayed through jet(s) 612 into end-winding cavity 220 at an angle.

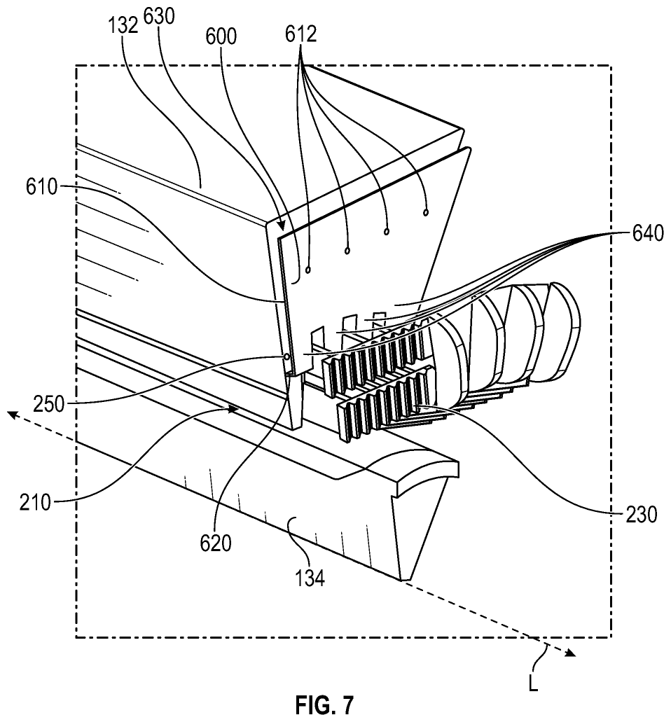

FIG. 7 is a perspective view of a portion of motor 130 of integrated compressor 100, according to an embodiment. As illustrated, flow splitter 600 may be formed with teeth-shaped features 640 on the radially inward end of flows splitter 600. Teeth-shaped features 640 form gaps therebetween to accommodate the connections of end-winding 230 to motor stator 132. Thus, axial cooling channel 250 can be provided closer to air gap 210, where the temperatures in motor stator 132 tend to be higher.

### INDUSTRIAL APPLICABILITY

An integrated compressor 100 may comprise a hermetically sealed electric motor 130 that drives a shaft to rotate rotor assemblies within a compression system 140. Compression system 140 compresses a fluid, supplied via an inlet path 142, and discharges the compressed fluid via an outlet path 148. For example, integrated compressor 100 may be incorporated into a gas pipeline to compress gas (e.g., methane) as the working fluid. In an embodiment, some of this working fluid may be extracted from compression system 140 and supplied as coolant to one or a plurality of cooling features in motor 130, to thereby cool various components of motor 130 that are prone to high temperatures.

In a first cooling feature, a motor stator 132 in motor 130 of integrated compressor 100 may be provided with axial cooling channels 250, radial cooling channels 260 that are not in direct fluid communication with axial cooling channel 250, and/or radial cooling channels 270 that are in direct fluid communication with axial cooling channel 250. The density of the cooling channels may be greater in areas of motor stator 132 that are prone to higher temperatures, with higher density in a radially inward portion of motor stator 132 relative to a radially outward portion of motor stator 132, in an axially central portion of motor stator 132 relative to an axially outer portion of motor stator 132, and/or in a aft portion of motor stator 132 relative to a forward portion of motor stator 132. Thus, a greater volume of coolant is provided to the portions of motor stator 132 that are prone to higher temperatures than portions of motor stator 132 that are prone to lower temperatures.

In a second cooling feature, jets may be used to spray coolant towards end-winding 230, to thereby cool end-winding 230. This second feature may be provided in addition to or instead of the first feature described above. In a first embodiment, angled jets 290 may be formed through a press plate 280 on the forward and/or aft ends of motor stator 132 to spray coolant towards an end-winding 230. In a second embodiment, a winding shroud 400 may be formed around forward and/or aft end-winding 230 to generally follow the shape of end-winding 230, with radial jets 430 formed through a shroud portion 410 to spray coolant within grooves 440, between ribs 420, towards end-winding 230. In a third embodiment, a flow splitter 600 may be provided on the forward and/or aft ends of motor stator 132 to form a radial cooling channel 630 that fluidly communicates with axial cooling channel 250, with angled jets 612 formed through a radial wall 610 of flow splitter 600 to spray coolant towards end-winding 230. One or more of these first, second, and third embodiments may be incorporated into the forward and/or aft portion of motor 130 of an integrated compressor 100 to cool end-winding 230.

It will be understood that the benefits and advantages described above may relate to one embodiment or may relate to several embodiments. Aspects described in connection with one embodiment are intended to be able to be used with the other embodiments. Any explanation in connection with one embodiment applies to similar features of the other embodiments, and elements of multiple embodiments can be combined to form other embodiments. The embodiments are not limited to those that solve any or all of the stated problems or those that have any or all of the stated benefits and advantages.

The preceding detailed description is merely exemplary in nature and is not intended to limit the invention or the application and uses of the invention. The described embodiments are not limited to usage in conjunction with a particular type of machine. Hence, although the present embodiments are, for convenience of explanation, depicted and described as being implemented in an integrated compressor, it will be appreciated that it can be implemented in various other types of compressors and machines with parts to be cooled, and in various other systems and environments. Furthermore, there is no intention to be bound by any theory presented in any preceding section. It is also understood that the illustrations may include exaggerated dimensions and graphical representation to better illustrate the referenced items shown, and are not considered limiting unless expressly stated as such.

What is claimed is:

1. A motor comprising:
a motor rotor with a longitudinal axis;
a motor stator encircling the motor rotor and concentric with the longitudinal axis,
wherein the motor stator includes at least one axial cooling channel that extends through the motor stator, parallel to the longitudinal axis; and
an air gap between the motor stator and the motor rotor.

2. The motor of claim 1, wherein the motor stator further comprises one or more radial cooling channels that extend through the motor stator, perpendicular to the longitudinal axis, and are not in direct fluid communication with the at least one axial cooling channel.

3. The motor of claim 1, wherein the motor stator further comprises one or more radial cooling channels that extend through the motor stator, perpendicular to the longitudinal axis, and are in direct fluid communication with the at least one axial cooling channel.

4. The motor of claim 1, wherein the motor stator further comprises:
a first set of one or more radial cooling channels that extend through the motor stator, perpendicular to the longitudinal axis, and are not in direct fluid communication with the at least one axial cooling channel; and
a second set of one or more radial cooling channels that extend through the motor stator, perpendicular to the longitudinal axis, and are in direct fluid communication with the at least one axial cooling channel.

5. The motor of claim 4, wherein the first set comprises a plurality of radial cooling channels, including a first radial cooling channel and a second radial cooling channel, wherein the first radial cooling channel is closer to a forward end of the motor stator than any radial cooling channel in the second set, and wherein the second radial cooling channel is closer to an aft end of the motor stator than any radial cooling channel in the second set.

6. The motor of claim 5, wherein the second set comprises a plurality of radial cooling channels.

7. The motor of claim 6, wherein a density of the second set, along an axial axis that is parallel to the longitudinal axis, is greater in an aft half of the motor stator than in a forward half of the motor stator.

8. The motor of claim 1, wherein the motor stator comprises a plurality of radial cooling channels that extend through the motor stator, perpendicular to the longitudinal axis, and wherein, for each of the plurality of radial cooling channels, a first end of the radial cooling channel is in fluid communication with the air gap and a second end of the radial cooling channel is in fluid communication with at least one cavity that is radially outward from the motor stator.

9. The motor of claim 8, wherein a density of the plurality of radial cooling channels, along an axial axis that is parallel to the longitudinal axis, increases from a forward end of the motor stator towards a center of the motor stator and increases from an aft end of the motor stator towards the center of the motor stator.

10. The motor of claim 1, further comprising at least one end-winding connected to an end of the motor stator and extending into an end-winding cavity, wherein the end comprises a press plate that includes a plurality of jets therethrough that fluidly connect a cavity that is radially outward from the motor stator to the end-winding cavity.

11. The motor of claim 10, wherein each of the plurality of jets is angled at an angle with respect to a radial axis that is perpendicular to the longitudinal axis.

12. The motor of claim 11, wherein the angle is between 35 and 55 degrees.

13. The motor of claim 1, further comprising:
at least one end-winding connected to an end of the motor stator and extending into an end-winding cavity; and
a winding shroud extending from the end of the motor stator and surrounding the at least one end-winding, wherein an inner diameter of the winding shroud increases as a distance from the end of the motor stator increases, and wherein the winding shroud includes a shroud portion comprising a plurality of jets therethrough.

14. The motor of claim 13, wherein each of the plurality of jets is radially oriented perpendicular to the longitudinal axis.

15. The motor of claim 13, wherein the winding shroud further comprises a plurality of ribs extending from the end of the motor stator, radially inward from the shroud portion, and configured to support the shroud portion, wherein the plurality of jets are positioned to fluidly connect a portion of the end-winding cavity that is radially outward from the winding shroud to a portion of the end-winding cavity that is radially inward from the winding shroud within grooves between the plurality of ribs.

16. The motor of claim 13, wherein the inner diameter of the winding shroud increases as the distance from the end of the motor stator increases at a same rate as an outer diameter of the at least one end-winding increases as the distance from the end of the motor stator increases.

17. The motor of claim 1, further comprising:
at least one end-winding connected to an end of the motor stator and extending into an end-winding cavity; and
a flow splitter connected to the end of the motor stator, wherein the flow splitter comprises a radial wall and at least one axial wall that define a radial cooling channel between the end of the motor stator and the radial wall, wherein the radial wall includes a plurality of jets therethrough that fluidly connect the radial cooling channel to the end-winding cavity, and wherein the radial cooling channel is in fluid communication with the at least one axial cooling channel.

18. The motor of claim 1, wherein the at least one axial cooling channel is a plurality of axial cooling channels that are spaced equidistantly apart around the longitudinal axis.

19. A motor comprising:
a motor rotor with a longitudinal axis;
a motor stator encircling the motor rotor and concentric with the longitudinal axis; and
an air gap between the motor stator and the motor rotor,
wherein the motor stator includes
at least one cooling channel that extends through the motor stator, parallel to the longitudinal axis, and
a plurality of radial cooling channels that extend through the motor stator, perpendicular to the longitudinal axis, wherein, for each of the plurality of radial cooling channels, a first end of the radial cooling channel is in fluid communication with the air gap and a second end of the radial cooling channel is in fluid communication with at least one cavity that is radially outward from the motor stator, and wherein at least a subset of the plurality of radial cooling channels are in direct fluid communication with the at least one axial cooling channel.

20. An integrated compressor comprising:
a shaft having a longitudinal axis;
a plurality of rotor assemblies attached to the shaft; and
a motor that drives rotation of the shaft around the longitudinal axis, wherein the motor comprises
a motor rotor that is concentric with the longitudinal axis,
a motor stator encircling the motor rotor and concentric with the longitudinal axis,
wherein the motor stator includes at least one axial cooling channel that extends through the motor stator, parallel to the longitudinal axis, and
an air gap between the motor stator and the motor rotor.
